(19) United States
(12) Patent Application Publication
(10) Pub. No.: US 2024/0183748 A1
(43) Pub. Date: Jun. 6, 2024

(54) TRANSMISSION BELT ARRANGEMENT

(71) Applicants: AKTIEBOLAGET SKF, GOTEBORG (SE); SKF MAGNETIC MECHATRONICS, SAINT-MARCEL (FR)

(72) Inventors: Lakdar SADI-HADDAD, Nogent sur Marne (FR); Josue SAURY, Saint-Marcel (FR); Lloyd BROWN, Singapore (SG); David BEGGS, Rizal (PH)

(21) Appl. No.: 18/514,255

(22) Filed: Nov. 20, 2023

(30) Foreign Application Priority Data
Dec. 1, 2022 (DE) 102022212954.7

(51) Int. Cl. G01M 13/023; F16G 1/00

(52) U.S. Cl. CPC G01M 13/023; F16G 1/00

(57) ABSTRACT

A transmission belt arrangement includes at least one transmission belt, at least one sensor configured to measure a parameter indicative of a surface mapping of the at least one transmission belt, and processing circuitry operatively connected to the at least one sensor and configured to determine a state of the at least one transmission belt based on the parameter indicative of the surface mapping.

### CROSS-REFERENCE

This application claims priority to German patent application no. 10 2022 212 954.7 filed on Dec. 1, 2022, the contents of which are fully incorporated herein by reference.

### TECHNOLOGICAL FIELD

The present disclosure is directed to an improved transmission belt and a condition monitoring method and arrangement for monitoring a state of a transmission belt. The disclosure is also directed to a method of issuing a signal indicative of a state of a transmission belt.

### BACKGROUND

Transmission belts are well-known components to transmit power between two rotatable shafts in a machine. Tension that is too low can allow the belt to slip, which can damage or destroy the belt due to overheating. Tension that is too high can damage the bearings that support the rotatable shafts that support belt by overloading the shafts. To ensure trouble-free operation and to benefit from all the properties of a transmission belt, special attention is paid to the initial installation. Once the belt is in operation, the belts are normally no longer monitored although they deteriorate over time. For instance, based on environmental conditions and other factors such as how the machinery is operated, the belt can deteriorate faster than expected, and this will decrease efficiency and potentially cause irreversible damage to the system. A way of monitoring the condition of a belt after initial installation is to provide the transmission belt with sensors for sensing and collecting data regarding a condition of the transmission belt and batteries to power the sensors. The data can then be read and analyzed. However, adding batteries and sensors complicates the manufacturing and add weight to the belt. Further, the manufacturing may be delayed based on availability of a particular sensor. Also, sensors tend to break, and batteries run out of power, thereby hindering the collection of data regarding the condition of the belt.

### SUMMARY

In view of the above, a first aspect of the present disclosure is to provide an improved transmission belt arrangement. A further aspect is to provide a method for condition monitoring at least one transmission belt by determining a state of the at least one transmission belt in a transmission belt arrangement. A yet further aspect is to provide an improved method for condition monitoring a transmission belt.

According to a first embodiment of the disclosure, a transmission belt arrangement includes at least one transmission belt, at least one sensor for providing a respective parameter indicative of a surface mapping of the at least one transmission belt, and processing circuitry for determining a respective state of the at least one transmission belt. The respective state of the at least one transmission belt is determined based on a respective surface mapping of the at least one transmission belt.

Using the transmission belt arrangement as disclosed herein, an improved transmission belt arrangement is provided, for which a respective parameter indicative of a surface mapping of at least one transmission belt is provided by at least one sensor, and a respective state of the at least one transmission belt is determined by processing circuitry. In particular, it has been realized that by using the respective surface mapping to determine the state of the at least one transmission belt, a sensor for sensing a state of a transmission belt does not need to be integrated in the transmission belt. Thereby, as fewer components are needed, a more robust and reliable transmission belt is achieved in a cost-effective manner. Furthermore, a simplified and cost-effective production of the belt is achieved.

The present disclosure also provides a better performing transmission belt because fewer components need to be integrated onto or into the belt, potentially weakening the structure of the belt. Furthermore, as less weight is added to a spot of the belt to provide for the sensing and transmitting functionality, the belt is less sensitive to becoming unbalanced, thereby providing for a better functioning transmission belt. Consequently, the machinery in which the transmission belt is applied is naturally also better operated. This is especially the case for applications with high rotating speeds.

By “a state” of the transmission belt as used herein is meant any physical parameter possible to measure by interpreting the surface mapping of the transmission belt. These physical parameters may be, but are not limited to, for instance force, temperature, strain, acceleration, elongation, pressure and/or humidity. These parameters are all relevant to either monitor the condition of the belt, or the environment in which the belt is operating. The parameters may also be used to monitor how the machinery in which the belt is installed is operated. These are all things that ultimately affects the condition and service life of the transmission belt.

The belt may at least partly be made from rubber. It may also be made from any other suitable material, or any combinations of suitable materials for providing the proper characteristics of the belt in question. The combination of materials may be for instance include metal wires to provide strength and/or parts made from fabric or textiles. The belt may comprise any other material or combination of suitable materials.

The at least one sensor may be attached to a guard enclosing the one or more transmission belts. It may also be positioned without being attached to the guard, while still being able to monitor the at least one transmission belt in order to e.g., measure the respective parameter indicative of the surface mapping of the at least transmission belt.

The processing circuitry may be wirelessly connected to the at least one sensor. Alternatively, the procession circuitry may be connected by a physical connection. The processing circuitry receives the respective parameter indicative of a surface mapping of the at least one transmission belt from the at least one sensor before determining a respective state of the at least one transmission belt.

By “a surface mapping” when used herein, is meant a mapping of the surface of the transmission belt. The surface mapping may indicate normative movements of the surface of a transmission belt over a period time, i.e., movements, such as sideways and/or up and down and/or lengthwise movements, corresponding to expected movements of a surface of a transmission belt. The period of time may be the period of time when the parameter was obtained, such as measured. The surface mapping may also for instance indicate movements deviating from a normative movement of a transmission belt, in which case it may indicate an elongation, acceleration, force and/or strain in the transmission belt.

A parameter indicative of a surface mapping may mean that the parameter comprises data enabling a surface mapping to be determined.

The at least one sensor may be any type of suitable sensor. In some examples, the at least one sensor is any one or more of a Light Detection and Ranging (LIDAR) sensor or a camera.

Optionally, he at least one sensor measures the parameter. The measurement may be performed in relation to a portion of the at least one transmission belt under traction. Still optionally, the processing circuitry obtains the parameter from the at least one sensor.

Optionally, at least one respective parameter is indicative of a three-dimensional surface mapping of the at least one transmission belt, and/or at least one parameter is indicative of a two-dimensional surface mapping of the transmission belt. This may e.g., depend on the type of sensor. Some sensor types, such as a LIDAR sensor, may provide a parameter indicative of a three-dimensional surface mapping. Other sensors, such as a camera, may provide a parameter indicative of a two-dimensional surface mapping.

Optionally, the respective surface mapping is determined by the processing circuitry. The surface mapping is a three-dimensional surface mapping. As mentioned above, a respective parameter may be indicative of a three-dimensional surface mapping or a two-dimensional surface mapping of a respective transmission belt. When a parameter is indicative of a three-dimensional surface mapping of a transmission belt, the processing circuitry is arranged to determine the three-dimensional surface directly on the basis of the parameter. When a parameter is indicative of a two-dimensional surface mapping of a transmission belt, the processing circuitry is arranged to determine the three-dimensional surface mapping by performing additional computer analysis of the parameter compared to when the parameter is indicative of a three-dimensional surface mapping.

Optionally, the respective state may be a state of elongation of the at least one transmission belt. As the belt is elongated, the processing circuitry determines the respective elongation, such as the state of the at least one transmission belt, based on the respective surface mapping of the at least one transmission belt. E.g., the surface mapping of a transmission belt may change with the elongation of the transmission belt. As such, the processing circuitry will determine a state of the transmission belt corresponding to the elongation of the transmission belt. The state of elongation may e.g., be determined as an elongation relative an initial length of a transmission belt. Thus, in some examples, the processing circuitry may determine a state of a transmission belt based on a comparison of a surface mapping of the transmission belt and an initial surface mapping of the transmission belt. The initial surface mapping is a surface mapping of the transmission belt when the transmission belt is new. Different transmission belts may be associated with different initial surface mappings, e.g., depending to the type of transmission belt.

Optionally, the at least one sensor provides the respective parameter indicative of the surface mapping of the at least one transmission belt to the processing circuitry. The processing circuitry may determine the respective surface mapping based on the respective parameter.

Optionally, a sensor of the at least one sensor provides a respective parameter indicative of a surface mapping of more than one transmission belt. In other words, one sensor may determine respective parameters for more than one transmission belt, and provide the respective parameters to the processing circuitry. This provides for an efficient monitoring of state of more transmission belts, since fewer sensors are needed.

The present disclosure is also directed to a method for determining a state of at least one transmission belt of a transmission belt arrangement. The transmission belt arrangement may include at least one transmission belt, at least one sensor for providing a respective parameter indicative of a surface mapping of the at least one transmission belt and processing circuitry for determining a respective surface mapping of the at least one transmission belt.

The method may further include determining a respective state of the respective at least one transmission belt on the basis of the respective surface mapping of the at least one transmission belt.

The disclosure also relates to a method for condition monitoring of at least one transmission belt by determining a state of the at least one transmission belt of a transmission belt arrangement according to embodiments herein. The method includes comparing the determined respective state with a predetermined criterion. A predetermined criterion may be for example, be a threshold. When the state is a state of elongation, the threshold may be a threshold related to elongation.

Optionally, the method for condition monitoring of at least one transmission belt may include issuing a notification if a respective signal fulfils a predetermined criterion. Fulfilling the predetermined criterion may e.g., mean that a respective signal is above the threshold.

### BRIEF DESCRIPTION OF THE DRAWINGS

Embodiments of the present disclosure will hereinafter be further explained by means of non-limiting examples with reference to the appended schematic figures wherein:

FIG. 1 is a schematic view, partly in section, of a transmission belt arrangement according to an embodiment of the present disclosure.

FIG. 2A is a schematic view, partly in section, of a transmission belt arrangement according to an embodiment of the present disclosure.

FIG. 2B is a schematic view, partly in section, of a transmission belt arrangement according to an embodiment of the present disclosure.

FIG. 3A is a schematic view, partly in section, of a transmission belt arrangement according to an embodiment of the present disclosure.

FIG. 3B is a schematic view, partly in section, of a transmission belt arrangement according to an embodiment of the present disclosure.

FIG. 4A is a schematic plan view of a transmission belt arrangement according to an embodiment of the present disclosure.

FIG. 4B is a schematic plan view of a transmission belt arrangement according to an embodiment of the present disclosure.

FIG. 5A is a schematic view of a transmission belt arrangement according to an embodiment of the present disclosure.

FIG. 5B is a schematic view of a transmission belt arrangement according to an embodiment of the present disclosure.

FIG. 6 is a flowchart of a method according to an embodiment of the present disclosure.

FIG. 7 is a flowchart of a method according to an embodiment of the present disclosure.

FIG. 8 is a flowchart of a method according to an embodiment of the present disclosure.

### DETAILED DESCRIPTION OF EMBODIMENTS

It should be noted that the drawings have not necessarily been drawn to scale and that the dimensions of certain features may have been exaggerated for the sake of clarity. Like reference signs in the drawings refer to the same or similar element, unless expressed otherwise.

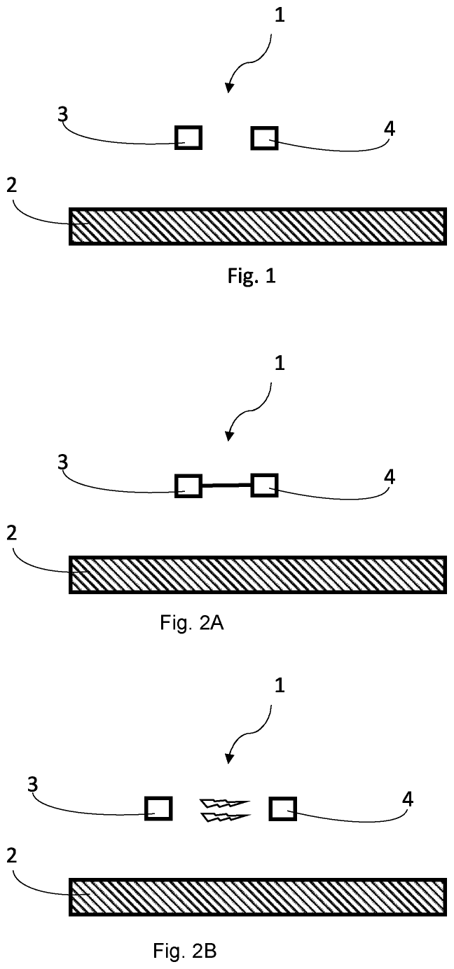

FIG. 1 is a schematic view of a transmission belt arrangement 1 according to an exemplary embodiment of the present disclosure. The transmission belt arrangement 1 comprises at least one transmission belt 2 and at least one sensor 3. It should be noted that only a portion of the at least one transmission belt 2 is shown in FIG. 1. The portion of the at least one transmission belt 2 depicted is the portion under traction (tension). The at least one sensor 3 is arranged to provide a respective parameter indicative of a surface mapping of the at least one transmission belt 2. The transmission belt arrangement 1 further comprises processing circuitry 4. The processing circuitry 4 is arranged to determine a respective state of the at least one transmission belt 2. The respective state of the at least one transmission belt 2 is determined on the basis of a respective surface mapping of the at least one transmission belt 2.

Fig. is a schematic view of a transmission belt arrangement 1 according to an exemplary embodiment of the present disclosure. Here, the processing circuitry 4 is connected to the at least one sensor 3 in a physical manner to transfer the parameter or any other data. For example, a wire from the processing circuitry 4 may be connected to the at least one sensor 3. Such connection to provide a signal indicative of a surface mapping of a transmission belt may physically be done in any other suitable way.

FIG. 2B depicts a schematic view of a transmission belt arrangement 1 according to an exemplary embodiment of the present disclosure. Here, the processing circuitry 4 is connected to the at least one sensor 3 in a wireless manner to transfer the parameter or any other data. For example, a wireless communication interface in the processing circuitry 4 may communicate wirelessly with a wireless interface of the respective at least one sensor 3. The wireless interface may be a wireless interface for communicating via e.g., Bluetooth or WiFi. Such connection to provide a parameter indicative of a surface mapping of a transmission belt may wirelessly be done in any other suitable way.

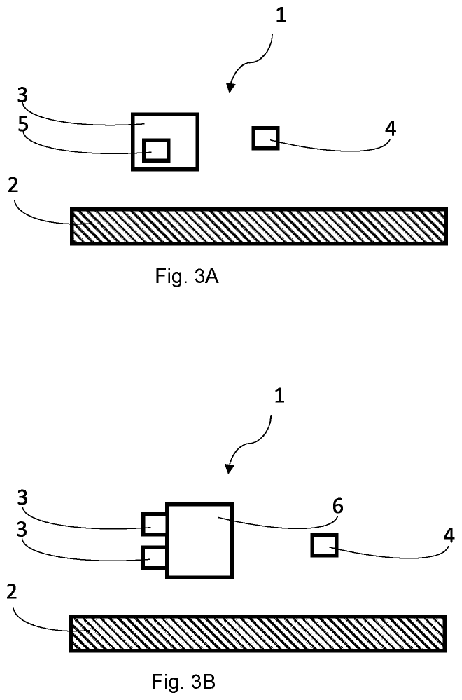

FIG. 3A is a schematic view of a transmission belt arrangement 1 according to an exemplary embodiment of the present disclosure. Here, the at least one sensor 3 of the transmission belt arrangement of 1 of any of FIG. 2A or 2B can be seen complemented with an integrated circuit 5 including memory. The integrated circuit 5 may be used for storing parameter data in case the parameter would not be able to be provided to the processing circuitry at some point. Then the parameter and any related data may be stored and provided later upon a successful connection between the processing circuitry 4 and the at least one sensor 3.

FIG. 3B is a schematic view of a transmission belt arrangement 1 according to an exemplary embodiment of the present disclosure. Here, the at least one sensor 3 of the transmission belt arrangement 1 of any of FIG. 2A or B can be seen to be connected with a separate integrated circuit 6. The integrated circuit 6 may be used for storing parameter data in case the parameter would not be able to be provided to the processing circuitry at some point. Then the parameter and any related data may be stored and provided later upon a successful connection between the processing circuitry 4 and the integrated circuit 6. In some examples, the transmission belt arrangement 1 of FIGS. 3A and B may be combined, such that the at least one sensor 3 is complemented with an integrated circuit 5 and the at least one sensor 3 is connected to the integrated circuit 6.

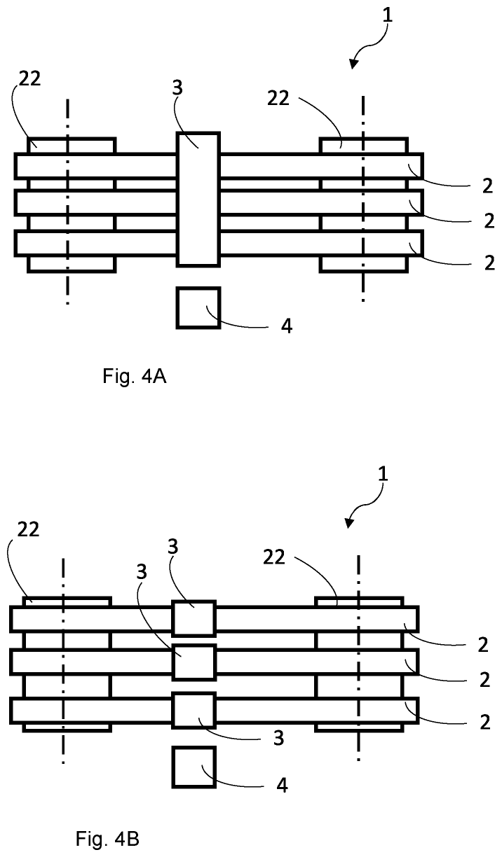

FIG. 4A is a schematic view of a transmission belt arrangement 1 according to an exemplary embodiment of the present disclosure. The transmission belt arrangement 1 comprises at least one transmission belt 2. The transmission belt arrangement 1 is depicted such that the portion of the transmission belt 2 under traction (tension) is shown. Here, a multi-belt application can be seen comprising a plurality of transmission belts 2 over two pulleys 22. One of the pulleys may be a drive pulley connected to an engine or motor, and the other pulley may be a driven pulley connected to a vehicle or machinery. The transmission belt arrangement 1 further includes at least one sensor 3 for measuring and providing a respective parameter indicative of a surface mapping of the transmission belts 2. In this example, the transmission belt arrangement 1 comprises one sensor 3. The one sensor 3 provides the respective parameters for each respective transmission belt 2.

FIG. 4B is a schematic view of a transmission belt arrangement 1 according to an exemplary embodiment of the present disclosure. Here, a multi-belt application can be seen, similar to that of FIG. 4A. According to this embodiment, the transmission belt arrangement 1 comprises more than one sensor 3. Each sensor 3 is arranged to provide a parameter indicative of a surface mapping of one transmission belt 2.

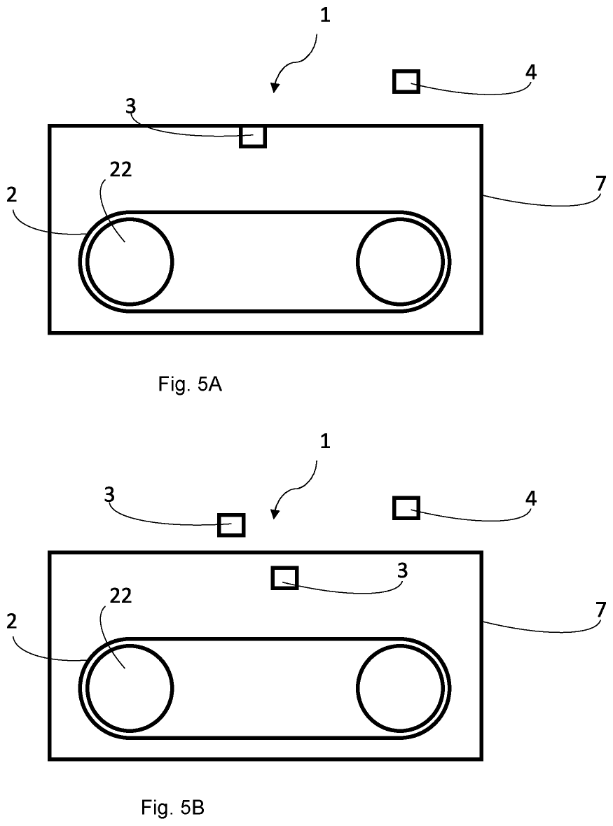

FIG. 5A is a schematic view of a transmission belt arrangement 1 according to an exemplary embodiment of the present disclosure. Here the transmission belt arrangement 1 as shown in any of FIGS. 1-4 is complemented with a guard 7 enclosing the at least one transmission belt 2. The at least one sensor 3 is attached to the guard 7 to monitor the at least one transmission belt 2 in order to e.g., measure the respective parameter indicative of the surface mapping of the at least transmission belt 2.

FIG. 5B is a schematic view of a transmission belt arrangement 1 according to an exemplary embodiment of the present disclosure. Here the transmission belt arrangement 1 as shown in any of FIGS. 1-4 is complemented with a guard enclosing the at least one transmission belt 2. The at least one sensor 3 is positioned to monitor the at least one transmission belt 2 in order to e.g., measure the respective parameter indicative of the surface mapping of the at least transmission belt 2. In this exemplary embodiment, the at least one sensor 3 is not attached to the guard 7. The at least one sensor 3 can be positioned outside the guard 7 or inside the guard 7. Alternatively, when the transmission belt arrangement 1 comprises more than one sensor 3, the more than one sensors 3 may be positioned both outside and inside the guard.

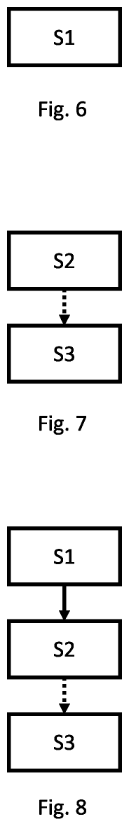

FIG. 6 depicts a flowchart of a method according to an exemplary embodiment of the present disclosure. The method is a method for determining at step S1 a state of at least one transmission belt 2 comprised in a transmission belt arrangement 1. The transmission belt arrangement 1 (see e.g., FIG. 1) comprises at least one transmission belt 2, at least one sensor 3 for determining a respective parameter indicative of a surface mapping of the at least one transmission belt 2, and a processing circuitry 4 for determining a respective surface mapping of the at least one transmission belt 2. The method comprises determining at step S1 a respective state of the at least one transmission belt 2 based on the respective surface mapping of the at least one transmission belt 2. For instance, a respective state of elongation of the at least one transmission belt 1 may be determined.

FIG. 7 is a flowchart of a method according to an exemplary embodiment of the present disclosure. The method is a method for monitoring a condition of at least one transmission belt 2 by determining at a step S1 a state of the at least one transmission belt 2 as described in FIG. 6. The method comprises comparing at a step S2 the determined respective state with a predetermined criterion. By comparing a determined state with a predetermined criterion, the state of a transmission belt 2 can classified as to whether further actions need to be taken.

The flowchart of the method can be seen comprising a further optional step S3 of issuing a notification if the determined state fulfils the predetermined criterion. This way, the situation can be analysed in order to take suitable actions to maintain an efficient operation of the transmission belt arrangement 1, such as planning for servicing or replacing one or more of the at least one transmission belt 2.

FIG. 8 is a flowchart of a method according to an exemplary embodiment of the present disclosure. Here, a combination of the methods for determining a state at least one transmission belt 2 as shown in FIG. 6 and for condition monitoring of at least one transmission belt 2 as shown in FIG. 7 can be seen.

It is to be understood that the present disclosure is not limited to the embodiments described above and illustrated in the drawings; rather, the skilled person will recognize that many changes and modifications may be made within the scope of the appended claims.

What is claimed is:

1. A transmission belt arrangement comprising:
at least one transmission belt,
at least one sensor configured to measure a parameter indicative of a surface mapping of the at least one transmission belt,
processing circuitry operatively connected to the at least one sensor configured to determine a state of the at least one transmission belt based on the parameter and/or based on the surface mapping.

2. The transmission belt arrangement according to claim 1, wherein the at least one sensor is a Light Detection and Ranging (LIDAR) sensor and/or a camera.

3. The transmission belt arrangement according to claim 1,
wherein the surface mapping is a two-dimensional surface mapping.

4. The transmission belt arrangement according to claim 1,
wherein the surface mapping is a three-dimensional surface mapping.

5. The transmission belt arrangement according to claim 1,
wherein the state is a degree of elongation of the at least one transmission belt.

6. The transmission belt arrangement according to claim 1,
wherein the sensor is configured to provide the parameter to the processing circuitry, and
wherein the processing circuitry is configured to determine the surface mapping from the parameter.

7. The transmission belt arrangement according to claim 1,
wherein the at least one transmission belt comprises a plurality of transmission belts, and
wherein one of the at least one sensor is configured to measure a parameter indicative of a surface mapping of each of the plurality of transmission belts.

8. A method for determining a state of at least one transmission belt of a transmission belt arrangement comprising:
sensing a parameter indicative of a surface mapping of the at least one transmission belt and outputting a signal indicative of the parameter,
processing the signal using processing circuitry to determine a surface mapping of the at least one transmission belt, and
determining a state of the at least one transmission belt on the basis of the surface mapping.

9. The method according to claim 8,
wherein processing the signal includes comparing the surface mapping with data indicative of a normative surface mapping.

10. The method according to claim 9,
issuing a notification if the comparing indicates a deviation from the normative surface mapping.
